(19) United States
(12) Patent Application Publication
(10) Pub. No.: US 2015/0084455 A1
(43) Pub. Date: Mar. 26, 2015

(54) Flux Directing, Pole Span Setting, Feature on Rotor Lamination of Air-Cooled Electric Motor/Generator

(71) Applicant: Kollmorgen Corporation, Radford, VA (US)

(72) Inventors: David Coulson, Radford, VA (US); Gary Hodge, Dublin, VA (US)

(21) Appl. No.: 14/389,174

(22) PCT Filed: Mar. 14, 2013
(86) PCT No.: PCT/US13/31349

§ 371 Date: Sep. 29, 2014

Related U.S. Application Data
(60) Provisional application No. 61/618,259, filed on Mar. 30, 2012.

(51) Int. Cl. H02K 1/27; H02K 9/02

(52) U.S. Cl. CPC H02K 1/276; H02K 9/02
USPC 310/59

(57) ABSTRACT

A rotor having a plurality of laminations joined together and mountable on a shaft for rotation relative to a stator of a rotary electric machine arrangement has a solid section that surrounds an opening within which the shaft is receivable. The solid section includes an outside diameter, magnet receiving voids, and steps delimiting a plurality of pole spans from flux directing features at sides of each of the pole spans. Adjacent flux directing features between adjacent pole spans are disposed on opposite sides of scalloped areas or other such recesses, permitting cooling air flow past the rotor. The invention also concerns a lamination usable together with additional laminations to provide such a rotor, as well as an arrangement, such as an AC motor, generator, or motor/generator, including a stator and such a rotor.

This application claims the priority of U.S. Provisional Application Ser. No. 61/618,259, filed Mar. 30, 2012, the entire disclosure of which is incorporated by reference into the present application.

### BACKGROUND OF THE INVENTION

1. Field of the Invention

The present invention concerns a pole span defining feature included in a rotor lamination forming part of a lamination stack constituting the rotor of an electric machine such as an AC motor, generator, or motor/generator with recess or channels to promote rotor cooling.

2. Description of Related Art

FIG. 1 of the present application illustrates a known interior permanent magnet rotor lamination 50. The winged features illustrated in FIG. 1 set a span that influences flux flow across the air gap between the winged features. During loaded conditions, when armature reaction influences the flux flow from the rotor to the stator, the pole span set by the winged features provides an optimized flow path to maximize output power from the generator. During unloaded conditions, the optimized pole span allows for a higher internal generator voltage (maximized BEMF of the machine). After testing, it was determined that inner polar cooling channels in the rotor formed by a stack of the laminations 50 should be present to allow for air flow through the generator, and, in subsequent designs, scallops were inserted in the inner polar areas of the rotor lamination, eliminating the possibility of using traditional pole span approaches such as those incorporating rotor laminations having configurations as shown in FIG. 1.

U.S. Patent Application Publication 2012/0074801 to Brown, et al. discloses a magnetic rotor with inset bridges to promote cooling. FIG. 2 of the present application corresponds to FIG. 1 of the Brown, et al. (801) publication, and illustrates a known interior permanent magnet rotor lamination 10, in plan view, with scallops or indentations 12 on the rotor outer diameter 13. The rotor lamination illustrated in FIG. 2, again, is a single layer interior permanent magnet rotor lamination. Each indentation 12 is located between adjacent pairs of magnet receiving voids or orifices 14 and 16, 18 and 20, 22 and 24, and 26 and 28, and each magnet receiving void or orifice of these pairs is separated from the other such void or orifice by a thin bridge 30 of rotor lamination material. In operation, permanent magnets (not shown) are affixed within the voids or orifices to cooperate with windings disposed around poles of a stator, within which the rotor lamination 10 is rotatable. A rotor shaft (not shown) is receivable within a shaft opening 32 to impart rotational motion to the rotor. The entire disclosure of the Brown, et al. ('801) publication is incorporated herein by reference as non-essential subject matter.

Other documents that may be of interest are U.S. Pat. No. 3,364,672 to Pfeffer, U.S. Pat. No. 5,051,634 to Overton, U.S. Pat. No. 7,057,323 to Horst, U.S. Patent Application Publication 2005/0140236 A1 to Jeong et al., U.S. Patent Application Publication 2006/0119203 A1 to Brown et al., U.S. Patent Application Publication 2007/0103024 A1 to Nakayama et al., U.S. Patent Application Publication 2008/0030108 A1 to Trago et al., U.S. Patent Application Publication 2008/0224558 A1 to Ionel, and U.S. Patent Application Publication 2009/0224624 to Kumar et al.

The IEEE paper Waveform Optimization of an AC Converter Machine, published May 25, 1989, identifying F. Wang as its author, teaches the value of square wave waveforms for improving the power out of a machine for a given size. This is achieved via a six phase machine and a linearly varying gap.

FIG. 3 illustrates standard pole shaping for large synchronous generators that is used for creating a more sinusoidal BEMF, as opposed to increasing a magnitude of the fundamental BEMF.

### SUMMARY OF THE INVENTION

According to the present invention, a flux directing pole cap is provided at the outside diameter of the rotor lamination. This pole cap is a non-circular feature, and serves to set the pole span of the machine. The non- circular pole cap is implemented into the lamination by cutting an arc in the outside diameter directly over the magnet pole. By including such features in rotor laminations, an attempt is made to provide maximum voltage to the generator load under loaded conditions. Benefits of the flux directing pole cap are optimized internal generator voltage, lowered inductance, lowered reactance, and an increased power factor. These combinations help increase generator efficiency.

In the process of designing a three phase permanent magnet generator, it was observed that different pole span settings provided different output voltages under certain load conditions. One design objective is to optimize the pole span to provide the highest voltage at generator loads. This characteristic helps minimize magnet material and coil turns. Pole span selection also directly impacts other generator parameters, such as inductance and reactance.

In one preferred arrangement, a rotor, formed from a plurality of laminations joined together, is mountable on a shaft for rotation relative to a stator of a rotary electric machine arrangement. The multilayer laminated rotor has a solid section that surrounds an opening within which the shaft is receivable. The solid section includes an outside diameter, magnet receiving voids, and steps delimiting a plurality of pole spans from flux directing features at sides of each of the pole spans. Adjacent flux directing features between adjacent pole spans are disposed on opposite sides of scalloped areas or other such recesses permitting cooling air flow past the rotor.

Each of the recesses mentioned permitting cooling air flow defines a scalloped area in the solid section, and the solid section mentioned defines a plurality of rotor poles, each of which includes a pair of the flux directing features, a single pole span between the flux directing features, and one of the steps located between each of the flux directing features and the single pole span. Each of the rotor poles, moreover, includes a pair of the magnet receiving voids, and each of the steps is disposed directly over one of the magnet receiving voids. The flux directing features permit air flow past the rotor between the recesses and the pole spans.

Selection of the pole spans may be made based on at least one of a maximum internal generator voltage, a minimum phase inductance, and a minimum generator reactance. In one particular arrangement contemplated, the rotor includes four rotor poles that cooperate with a thirty six slot stator. The pole spans, steps, and flux directing features mentioned provide an air gap of varying cross section between the rotor and a stator associated with the rotor, with the air gap being at a minimum between the pole spans and the stator.

The invention also concerns a lamination, usable together with additional laminations to provide such a rotor, as well as an arrangement including a stator and a rotor configured in the manner discussed.

### BRIEF DESCRIPTION OF THE DRAWING FIGURES

FIG. 1, discussed above, is a plan view of a known interior permanent magnet rotor lamination having winged features that influence flux flow.

FIG. 2, discussed above, illustrates a known interior permanent magnet rotor lamination, in plan view, with scallops or indentations on the rotor outer diameter to permit cooling fluid flow.

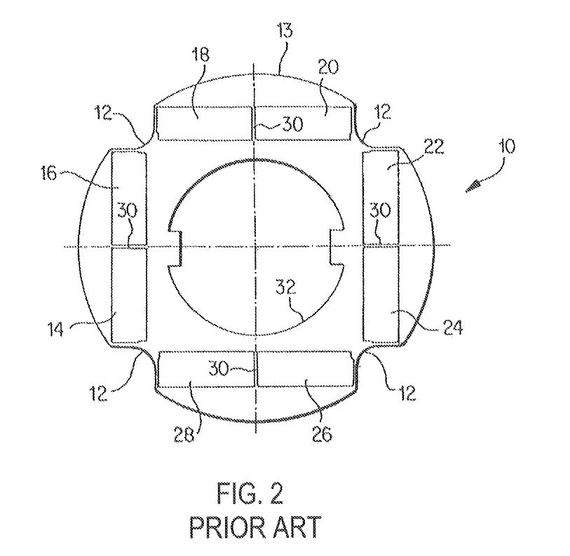

FIG. 3, discussed above, illustrates standard pole shaping for large synchronous generators.

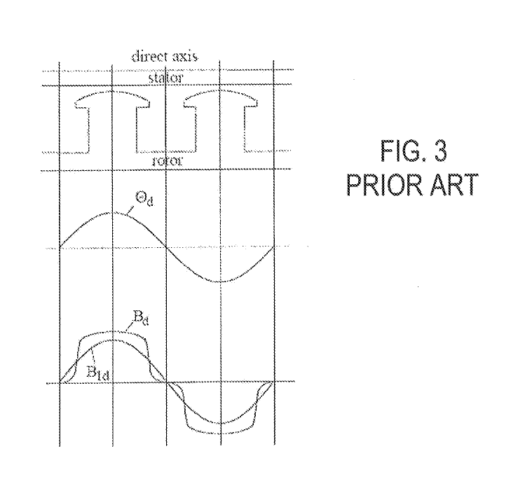

FIG. 4 illustrates a rotor having flux directing pole cap features according to the present invention.

FIG. 5 is an enlarged view of a part of FIG. 4.

FIG. 6 is a schematic illustration of the lines of magnetic flux in an arrangement having a rotor configured in accordance with the present invention.

### DETAILED DESCRIPTION OF THE INVENTION

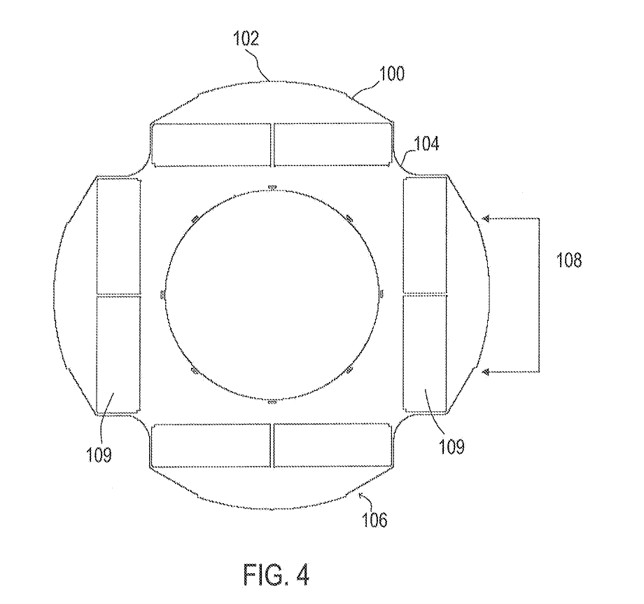

As shown in FIG. 4, according to the present invention, a flux directing pole cap feature 100 is provided at the outside diameter 102 of a rotor lamination forming part of an overall laminated rotor 106. This pole cap feature 100 is non circular, and serves to set the pole span 108 of the machine. The non-circular pole cap feature 100 is implemented into the lamination by cutting arcs at the outside diameter 102 directly over the magnet pole. Although such characteristics are not to be considered limiting, in one configuration of the invention, the machine is a four pole, 36 slot generator designed to operate at 45 to 60 Hz and provide a minimum of 338 VAC at 45 Hz and 449 VAC at 60 Hz.

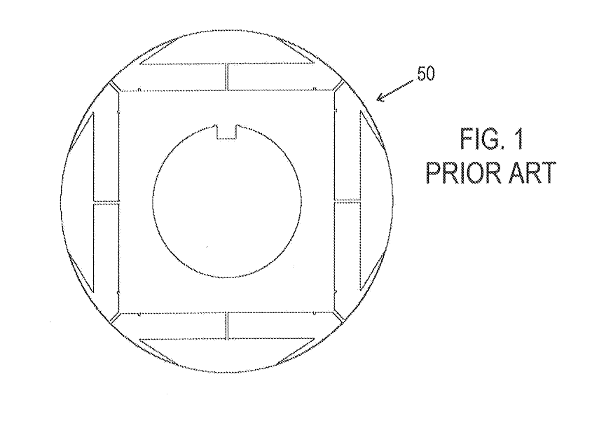

In conventional arrangements, buried magnet or interior permanent magnet designs originally had small inner polar cooling channels, and a pole span could be set in a traditional manner, supported by prior art. In the known interior permanent magnet rotor lamination 50 of FIG. 1, for example, this approach was accomplished using wing features that extend toward one another and set an angular distance above the pole.

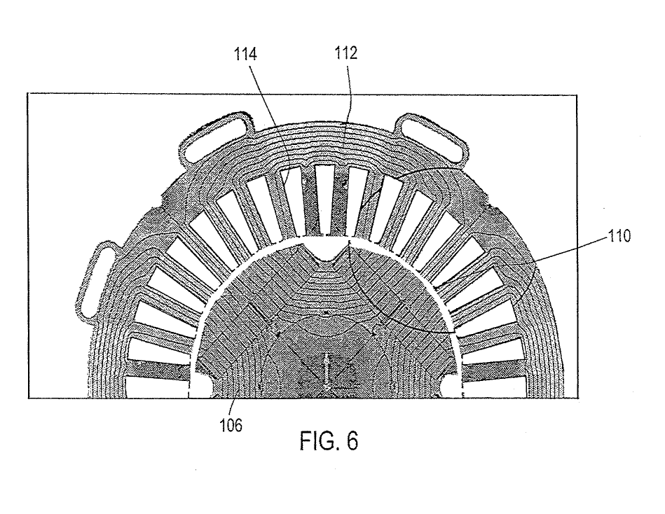

In the alternative pole span delineating approach of the present invention, non-circular pole cap arcs or other features 100 are implemented into the lamination by designing arcs above the magnet pole on the outside diameter 102 of the rotor 106 just above the magnet receiving voids, orifices, or slots 109. Areas of the rotor 106 between the poles (inner polar) includes scalloped areas 104 that allow air to flow axially through the rotor 106. The radial magnetic air gap 110 (FIG. 6) is at a minimum on the rotor lamination outside diameter 102 in the area above the permanent magnets received in the voids 109, and gets larger in the area of the lamination outside of a pole span 108 but between the pole cap arcs or other features 100 and the scalloped areas 104 forming air flow regions. This variable air gap influences the flux and directs it to the arced section of the rotor 106 more exactly above the magnets. This becomes particularly important for maximizing flux linkage with reactive loads; as the loads become more reactive, the current angle shifts away from the voltage in the generator system. When this occurs, armature reaction will try to divert the flux in areas that are not beneficial to voltage production. The pole cap serves to guide the flux across the gap, minimizing the effect of armature reaction and maximizing generator output voltage. FIG. 6 is a schematic illustration of the lines of magnetic flux in an arrangement having the rotor 106 rotationally disposed within a stator 112 having stator teeth 114 and associated wire coils (not shown).

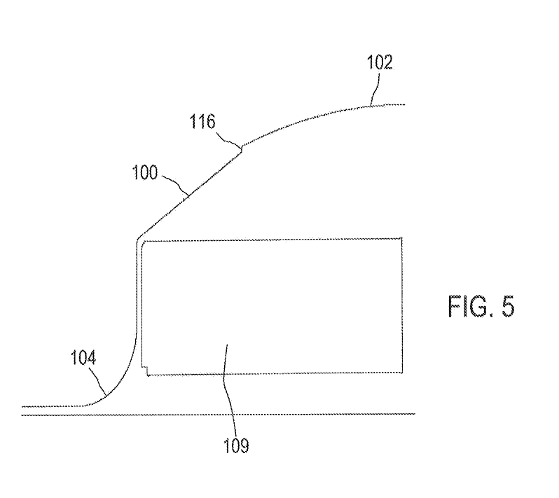

FIG. 5 is an enlarged view of a part of FIG. 4 showing one of the scalloped areas 104 adjacent one of the magnet receiving voids, orifices, or slots 109 of the rotor 106. The non-circular pole cap arcs or other features 100 are delineated with respect to the pole span 108 (FIG. 4) of the illustrated rotor lamination by a step down feature 116 that can more concisely be referred to simply as a “step.” Such step down features serve to increase output voltage and, as shown in FIG. 6, focus the flux in the teeth aligned with the magnets received within the voids.

As noted above, by including such features in rotor laminations, an attempt is made to provide maximum voltage to the generator load under loaded conditions. Benefits of the flux directing pole cap are optimized internal generator voltage, lowered inductance, lowered reactance, and an increased power factor. These combinations help increase generator efficiency.

Pole span selection is optimized by providing a maximum internal generator voltage, a minimum phase inductance, and a minimum generator reactance. By decreasing generator reactance, the power factor of the complete system increased, increasing efficiency. The reduction of inductance due to an optimized pole span lowers the voltage drop across the generator internal impedance during loaded conditions, increasing the generator output power.

The invention should be readily observable, is operable as evidenced by way of its use on certain prototypes, and increases the voltage generated by 5.6% relative to arrangements without a step down feature.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A rotor having a plurality of laminations joined together and mountable on a shaft for rotation relative to a stator of a rotary electric machine arrangement, comprising:
a solid section surrounding an opening within which the shaft is receivable, the solid section including an outside diameter, magnet receiving voids, and steps delimiting a plurality of pole spans from flux directing features at sides of each of the pole spans,
wherein adjacent flux directing features between adjacent pole spans are disposed on opposite sides of recesses permitting cooling air flow past the rotor.

2. The rotor of claim 1, wherein each of the recesses permitting cooling air flow defines a scalloped area in the solid section.

3. The rotor of claim 1, wherein the solid section defines a plurality of rotor poles.

4. The rotor of claim 3, wherein each of the rotor poles includes a pair of said flux directing features, a single pole span between the flux directing features, and one of the steps located between each of the flux directing features and the single pole span.

5. The rotor of claim 3, wherein each of said rotor poles includes a pair of the magnet receiving voids, and each of the steps is disposed directly over one of the magnet receiving voids.

6. The rotor of claim 1, wherein the flux directing features permit air flow past the rotor between the recesses and the pole spans.

7. The rotor of claim 1, wherein selection of the pole spans is made based on at least one of a maximum internal generator voltage, a minimum phase inductance, and a minimum generator reactance.

8. The rotor of claim 1, wherein the rotor includes four rotor poles that cooperate with a thirty six slot stator.

9. The rotor of claim 1, wherein the pole spans, steps, and flux directing features provide an air gap of varying cross section between the rotor and a stator associated with the rotor.

10. The rotor of claim 9, wherein the air gap is at a minimum between the pole spans and the stator.

11. A lamination, usable together with additional laminations to provide a rotor arrangement mountable on a shaft for rotation relative to a stator of a rotary electric machine arrangement having a plurality of laminations joined together to form a multilayer laminated rotor, comprising:
a solid section surrounding an opening within which the shaft is receivable, the solid section including an outside diameter, magnet receiving voids, and steps delimiting a plurality of pole spans from flux directing features at sides of each of the pole spans,
wherein adjacent flux directing features between adjacent pole spans are disposed on opposite sides of recesses to permit cooling air flow.

12. The lamination of claim 11, wherein each of the recesses to permit cooling air flow defines a scalloped area in the solid section.

13. A rotary electric machine arrangement including a stator and a rotor having a plurality of laminations joined together and mountable on a shaft for rotation relative to the stator, comprising:
a solid section surrounding an opening within which the shaft is receivable, the solid section including an outside diameter, magnet receiving voids, and steps delimiting a plurality of pole spans from flux directing features at sides of each of the pole spans,
wherein adjacent flux directing features between adjacent pole spans are disposed on opposite sides of recesses permitting cooling air flow past the rotor.

14. The arrangement of claim 13, wherein each of the recesses permitting cooling air flow defines a scalloped area in the solid section.

15. The arrangement of claim 13, wherein the solid section defines a plurality of rotor poles.

16. The arrangement of claim 15, wherein each of the rotor poles includes a pair of said flux directing features, a single pole span between the flux directing features, and one of the steps located between each of the flux directing features and the single pole span.

17. The arrangement of claim 15, wherein each of said rotor poles includes a pair of the magnet receiving voids, and each of the steps is disposed directly over one of the magnet receiving voids.

18. The arrangement of claim 13, wherein the flux directing features permit air flow past the rotor between the recesses and the pole spans.

19. The arrangement of claim 13, wherein selection of the pole spans is made based on at least one of a maximum internal generator voltage, a minimum phase inductance, and a minimum generator reactance.

20. The arrangement of claim 13, wherein the rotor includes four rotor poles that cooperate with a thirty six slot stator.
